(19) United States
(12) Patent Application Publication
(10) Pub. No.: US 2012/0234047 A1
(43) Pub. Date: Sep. 20, 2012

(54) METHOD FOR FLUID-TIGHT ASSEMBLY OF TWO PARTS IN SILICON NITRIDE

(75) Inventors: Michel Creau, Vannes (FR); Gregory Etchegoyen, Ambazac (FR); Isabelle Porte, Condat-Sur-Vienne (FR)

(73) Assignee: AREVA NC, Paris (FR)

(21) Appl. No.: 13/512,594

(22) PCT Filed: Nov. 30, 2010
(86) PCT No.: PCT/EP2010/068474

§ 371 Date: May 29, 2012

(30) Foreign Application Priority Data
Dec. 2, 2009 (FR) 0958582

(51) Int. Cl. C03C 27/00

(52) U.S. Cl. 65/43

(57) ABSTRACT

A method for the fluid-tight assembly of two parts silicon nitride respectively comprising a male end and a female end, each of these ends being provided with mechanical assembly means capable of cooperating together and which, under assembling conditions, delimit a space -between them, said method comprises the assembling of the said parts by cooperation of the mechanical assembly means of the male and female ends, and filling of the space existing between these assembly means with a glass joint, and is characterized in that this filling comprises: coating, before assembling of the parts, the mechanical means of one and/or the other of the male and female ends with a borosilicate glass paste; and applying heat treatment to the parts after the assembling thereof.

### TECHNICAL FIELD

The present invention relates to a method allowing parts in silicon nitride to be assembled together with a view to obtaining hollow or solid structures, of long length, ensuring a perfect fluid-tight seal between these parts.

The invention finds particular application in the field of the processing of waste nuclear fuel, in particular to form electrolytic membranes intended for electrolysers dedicated to the electrochemical dissolution of actinide oxides such as plutonium oxide. Said electrolysers are described for example in French patent application published under n° 2 738 165 (reference [1]).

However, it can also be used for forming tubular filters for molten metals.

### STATE OF THE PRIOR ART

The forming of a structure in silicon nitride of great length i.e. measuring several metres in length, necessarily includes the assembly of several parts if the structure it is desired to manufacture must have a length greater than the maximum length of the parts that the machines are able to produce.

If the silicon nitride structure is intended to be used as electrolytic membrane of an electrolyser for the electrochemical dissolution of actinide oxides, the quality of the assembly of the parts which are to form this structure is of prime importance since this assembly must be able to obtain a fluid-tight junction, between the assembled parts, and straightness without deteriorating the intrinsic properties of the silicon nitride and in particular its mechanical strength, resistance to acids, porosity and permeability to pressurized fluids.

In French patent application published under n° 2 131 571 (reference [2]), a method was proposed for forming the junction between two dense or porous parts in silicon nitride, by means of a glass material.

This method consists of depositing on the edge of one thereof a glass material in the form of a powder or paste which comprises silica, alumina and an oxide chosen from the oxides of magnesium, calcium, barium, strontium and manganese, then of placing the parts edge to edge and heating these parts whilst holding them compressed one against the other at the melt temperature of the glass so that the glass melts and on cooling ensures the junction between said parts.

This method is therefore based on forming an edge-to-edge junction of the two parts in silicon nitride via an aluminosilicate glass whose mechanical strength is insufficient for it alone to ensure the mechanical supporting of structures of large dimensions and in particular those of great length.

In addition, the melt temperatures of the aluminosilicate glasses used in this method requires heating the parts to temperatures of at least 1200° C. and in an inert atmosphere (N₂ or argon) to prevent the silicon nitride from oxidizing.

More recently, in Japanese patent application published under n° 2004/224594 (reference [3]), a method was proposed for assembling two dense parts in silicon nitride which comprises both the mechanical assembly of these parts and the forming a glass joint between the parts thus assembled.

In this method, the parts which are respectively provided at one of their ends with external and internal threads are assembled by screwing.

Then a mixture of silica powders and other compounds of mineral oxide and alkaline nitrate type are introduced into the space existing between the parts thus assembled. These parts are then subjected to heat treatment which allows the different powders to react with each other and to form a glass which, after cooling, ensures a sealed junction between the said parts.

This method requires the existence of a clearance between the parts to be assembled that is sufficiently large so that it is possible to introduce the mixture of powders between these parts once they are screwed. Yet said clearance may be detrimental to geometric precision and, in particular, to the straightness of the assembly obtained.

In addition, the introducing of a mixture of powders, in particular alkaline nitrate powders between the parts inevitably leads to volatilisation of some chemical species at the time of heat treatment, which may translate as homogeneity defects in the composition or microstructure of the glass joint. Yet the existence of such defects, whether potential or actual, prevents such method from being used to assemble parts in silicon nitride for the forming of a structure intended to be used in a corrosive environment such as that in which electrolytic dissolution of actinide oxides takes place.

The Inventors have therefore set themselves the objective of providing a method with which it is possible to form a fluid-tight assembly between two parts in silicon nitride free of the above-mentioned shortcomings.

### DISCLOSURE OF THE INVENTION

This objective and others are achieved with the invention which proposes a method for the fluid-tight assembly of two parts in silicon nitride of which one comprises a male end and the other comprises a female end, each of these ends being provided with mechanical assembly means which are capable of cooperating together and which, under assembling conditions, delimit a space between them, the method comprising:

the assembly of the said parts by cooperation between the mechanical assembly means of the male and female ends; and

filling the space, existing under assembling conditions, between these assembly means with a glass joint;

and is characterized in that the filling comprises:

before assembling the parts, coating the mechanical assembly means of one and/or the other of the male and female ends with a borosilicate glass paste;

after assembling the parts, applying heat treatment thereto to induce the formation in said space of a borosilicate glass joint by softening and flow of the borosilicate glass present in said paste, followed by solidification of the joint thus formed.

Therefore, according to the invention, to fill the space existing between the mechanical assembly means of the male and female ends of the parts, use is made not of a mixture of powders intended to form a glass in situ by reaction between them, but a paste which contains a borosilicate glass; in addition this paste is not placed in said space once the parts are assembled but it is deposited on the mechanical assembly means of one and/or the other of the male and female ends of the parts before they are assembled together.

Therefore, both the need to provide for a major clearance between the assembly means of the two parts and the risk of obtaining a glass joint having defects are eliminated, such defects likely to weaken the strength of the joint particularly in a corrosive environment.

In the foregoing and in the remainder hereof, by [symbol] borosilicate glass [symbol] is meant a glass of which at least 50 mass % is formed of a silicon oxide and a boron oxide, this glass possibly also containing other mineral oxides provided that these oxides do not represent more than 50% of its total mass.

Also by [symbol] working temperature [symbol] of a borosilicate glass is meant the temperature at which this glass has a viscosity of 1000 Pa.s such as determined by standard ISO 7884-5:1987.

The borosilicate glass used in the method of the invention is preferably chosen from among the borosilicate glasses having:

(1) a coefficient of thermal expansion close to that of silicon nitride i.e. from 2.5×10⁻⁶/° C. to 5.0×10⁻⁶/° C. at between 20° C. and 800° C. and, better still, from 3.0×10⁻⁶/° C. to 3.9×10⁻⁶/° C. at between 20° C. and 800° C., so as to avoid phenomena of fissuring or loss of cohesion in the glass joint on cooling of the parts; and/or

(2) a working temperature of 900° C. to 1300° C. and, better still, from 1000° C. to 1200° C.;

evidently, the borosilicate glass ideally having both these characteristics.

It is desirable that the borosilicate glass should also have excellent resistance to corrosion and in particular to acid attack, bearing in mind that the requirements in terms of corrosion resistance will depend on the environment in which the parts in silicon nitride, assembled with the method of the invention, are intended to be used. Therefore, for example, for use in electrolysers intended for the electrochemical dissolution of actinides, it is preferable that the borosilicate glass should be chosen from among the borosilicate glasses which, when subjected to a resistance test to acid attack by immersion in 5% hydrochloric acid at 95° C. for 24 hours, shows a loss of thickness of between 0.025 μm and 0.25 μm (which places them in class 2 for this test).

In addition, the borosilicate glass is preferably present in the glass paste in the form of a powder whose particle size, such as determined by laser particle measurement, is advantageously between 0.1 μm and 1 mm and, better still, between 1 μm and 100 μm, this powder being dispersed in a binder allowing the ensured binding of the glass paste with the silicon nitride on which it is deposited, said binder particularly being a resin of the type of those used in serigraphy.

The borosilicate glass-based paste may, in addition to the borosilicate glass powder and the binder, comprise a dispersing agent for mineral powders, e.g. of phosphoric ester type, able to prevent the formation of agglomerates in this paste, and a solvent that is used to adjust the viscosity of the said paste.

This solvent may be water or a water-based solvent. However, advantageous use is made of a volatile organic solvent, e.g. an alcohol such as ethanol, propanol or isopropanol, said solvent effectively having the advantage of drying rapidly and of limiting drying-related stresses and, in particular, the risks of the glass paste fissuring on drying.

Preferably the paste containing borosilicate glass has the following weight percentage content:
30 to 90% and, better still, from 50 to 80% of borosilicate glass powder;
up to 30% and, better still, up to 15% of binder;
from 0 to 5% and, better still, from 0 to 2% of dispersant for mineral powders; and
from 0 to 50% and, better still, from 15 to 40% of solvent.

The viscosity of this paste, such as determined at ambient temperature and by means of a rotational viscometer with defined gradient of shear velocity, is typically between 0.01 Pa.s and 100 Pa.s under a shear gradient of 1 to 10 s⁻¹.

As previously indicated, it is possible to coat the borosilicate glass paste either solely on the male end of the mechanical assembly means, or solely on the female end of the mechanical assembly means, or on both.

The coating of the male end mechanical assembly means is advantageously obtained by immersion and more particularly using the technique known as dip-coating, which allows layers of homogeneous thickness to be formed on a substrate, whilst the coating of the female end of the mechanical assembly means is rather more obtained using a flat blade instrument of spatula type. In this case, the borosilicate glass paste that is used for these coatings preferably has a viscosity, such as determined at ambient temperature and by means of a rotational viscometer with defined shear velocity gradient, of 0.01 Pa.s to 5 Pa.s under a shear gradient of 1 to 10 s⁻¹.

The solvent present in the borosilicate glass paste thus deposited is then advantageously removed either by simple drying in open air or by forced drying e.g. in an oven with controlled temperature, and the parts are preferably immediately assembled.

In this respect, according to the invention, it is preferred that the parts should be assembled by screwing. In other words, it is preferred that the mechanical assembly means consist of an external thread for the male end and an internal thread for the female end.

However, it is also possible to obtain the assembly of the parts by tack welding, bayonet, key-in or similar type of assembly means.

Since the male end has a free end which, under screw conditions, faces a shoulder present in the female end and the female end has a free end which, under screw conditions, faces a shoulder in the male end, screwing is preferably obtained so that, between each of said free ends and the opposite-facing shoulder, a space is formed whose width (i.e. the smallest dimension) preferably does not exceed 5 mm and which is filled with borosilicate glass using a syringe for example. In this case, the paste used for such filling preferably has a viscosity, such as determined at ambient temperature and by means of a rotational viscometer with defined shear velocity gradient, of 0.01 Pa.s to 5 Pa.s under a shear gradient of 1 to 10 s⁻¹.

The heat treatment is advantageously performed under conditions which, in addition to softening and flowing of the borosilicate glass paste, allows the mechanical adhesion of this glass to the silicon nitride and the absence of any fissuring or loss of cohesion of the said glass after this treatment.

On this account, this heat treatment preferably comprises:

one or more temperature rises at a rate of 0.1° C./minute to 10° C./minute, optionally with one or more intermediate isothermal temperature holds, until a maximum temperature is reached, this maximum temperature being intended to allow the flowing of the borosilicate glass and typically lying between 600° C. and 1200° C. and, better still, between 600° C. and 1000° C.;

a temperature hold at the maximum temperature, this hold typically lasting between 1 minute and 120 minutes, and ideally being less than 30 minutes so as to limit oxidation of the silicon nitride;

one or more temperature drops at a rate of 0.1° C./minute to 5° C./minute, optionally with one or more intermediate isothermal temperature holds, until a temperature is reached that is slightly lower than the glass transition temperature of borosilicate glass, i.e. in practice of the order of 50° C. below the glass transition temperature of the borosilicate glass, so as to limit stresses in this glass; and

one or more temperature drops at a rate of 0.1° C./minute to 5° C./minute until ambient temperature is reached.

According to the invention, it is possible to fill the cavities which are present in the glass joint obtained after the heat treatment and are accessible, with the borosilicate glass paste and to subject the parts to further heat treatment identical to the preceding treatment one or several times.

To guarantee that the assembly remains within the desired dimensional tolerances, each of the male and female ends may additionally comprise guide means capable of cooperating together and which delimit a space between them, when being assembled, whose width (i.e. smallest dimension) is advantageously smaller than the width of the space existing between the mechanical assembly means. For example, if the width of the space existing between the mechanical assembly means is preferably from 0.1 mm to 4 mm, the width of the space existing between the guide means is preferably from 0.05 mm to 2 mm.

The method then advantageously and additionally comprises, before assembly of the parts, the coating of all or part of the guide means of one and/or the other of the male and female ends, which is performed simultaneously and in the same manner as the coating of the mechanical assembly means of the end concerned.

According to the invention, the parts to be assembled are preferably hollow parts i.e. a conduit passes through them, these hollow parts possibly being of straight circular section, quadrangular, ovoid or other.

However, the method of the invention can perfectly well be used to assemble solid parts, these solid parts also possibly being of circular straight section, quadrangular, ovoid or other.

The method of the invention has numerous advantages. In addition to allowing the assembly of two parts in silicon nitride ensuring a fluid-tight junction between them, it also has the advantage of:

heeding the geometric and dimensional tolerances defined for the assembly;

heeding the intrinsic properties of silicon nitride;

leading to a glass junction free of homogeneity defects and hence particularly capable of resisting a corrosive environment;

able to be used to assemble parts of large size both transversally and longitudinally;

only requiring commercially available materials; and

being relatively simple to implement.

This method is therefore particularly adapted to the fabrication of wells used as cathode compartments in electrolysers dedicated to the electrochemical dissolution of actinide oxides.

Other advantages and characteristics of the invention will become better apparent on reading the remainder of the description given for illustrative purposes and with reference to the appended drawings.

### BRIEF DESCRIPTION OF THE FIGURES

FIG. 1 is a schematic longitudinal section view of the assembling between the male and female ends of the two parts of an assembly according to a first embodiment of the method of the invention.

FIG. 2 is a schematic longitudinal section view of the assembling between the male and female ends of the two parts of an assembly according to a second embodiment of the method of the invention.

FIG. 3 is a schematic longitudinal section view of the assembling between the male and female ends of an assembly according to a third embodiment of the method of the invention.

FIG. 4 is a schematic longitudinal section view of the assembling between the male and female ends of the two parts of an assembly according to a fourth embodiment of the method of the invention.

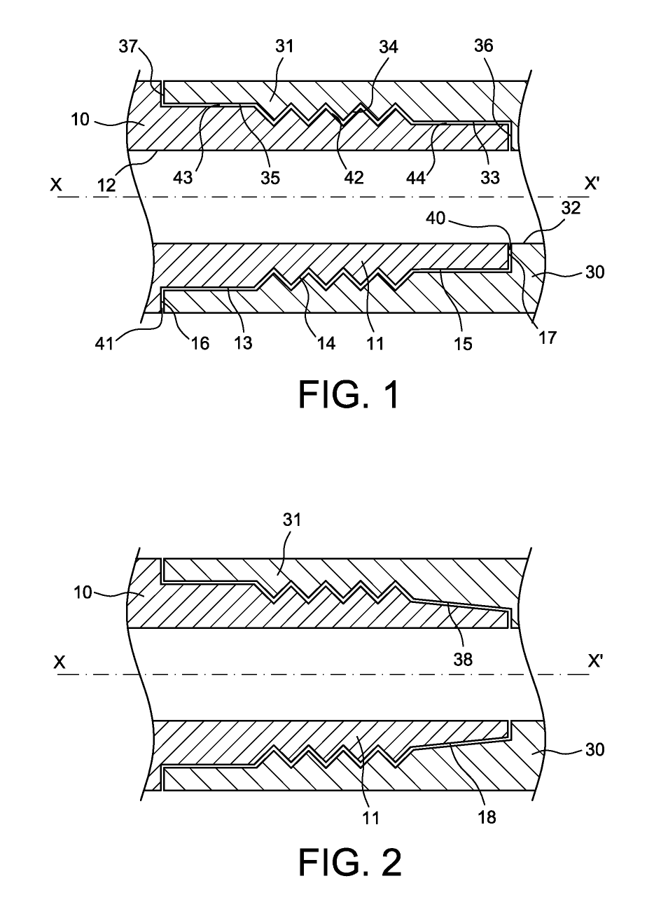

In FIGS. 1 to 4, parts carrying the same reference numbers relate to identical or similar parts.

### DETAILED DESCRIPTION OF PARTICULAR EMBODIMENTS

Reference is first made to FIG. 1 which shows the assembling between the male and female ends of two parts 10 and 30 of an assembly according to a first embodiment of the method of the invention.

Each of the parts 10 and 30 is in the form of a tube with straight circular section, through which a conduit passes from end to end, respectively 12 and 32 of longitudinal axis XX′, for example for the circulation of a fluid.

As can be seen in FIG. 1, the part 10 comprises a male end 11 which is formed by a first cylindrical part 13 of straight circular section, whose outer diameter is smaller than the outer diameter of the tube, followed by a thread 14 itself followed by a second cylindrical part 15 of straight circular section, whose outer diameter is smaller than that of the first cylindrical part 13.

The part 30 comprises a female end 31 which is formed of a first bore 33 followed by an internal thread 34 itself followed by a second bore 35, which are respectively of shape mating with the shape of the second cylindrical part 15, the external thread 14 and the first cylindrical part 13 of the male end of part 10.

The part 10 comprises a shoulder 16 which connects the first cylindrical part 13 to the remainder of this part.

Similarly, the part 30 comprises a shoulder 36 which connects the first bore 33 to the remainder of this part.

The distance which separates the shoulder 16 from the free end 17 of the male end of part 10 is equal or substantially equal to the distance which separates the shoulder 36 from the free end 37 of the female end of part 30, so that incomplete assembly of the parts 10 and 30, in the absence of any depositing of borosilicate glass paste on the male and female ends of these parts, translates as the existence of two identical or near-identical longitudinal clearances 40 and 41, of which one is located between the shoulder 36 and the free end of the male end of part 10 whilst the other is located between the shoulder 16 and the free end of the female end of part 30.

As can be seen in FIG. 1 the dimensions of the different parts forming the male end of part 10 and those of the different parts forming the female end of part 30 are chosen so that, under assembling conditions of the parts 10 and 30 and in the absence of any deposit of borosilicate glass paste on the male and female ends of these parts, there exist a first clearance 42 between the threads of the external thread 14 and internal thread 34, a second clearance 43 between the first cylindrical part 13 and the second cylindrical bore 35, and a third clearance 44 between the second cylindrical part 15 and the first cylindrical bore 33, the clearances 43 et 44 being identical or near-identical relative to each other but smaller than the clearance 42.

Therefore, the guiding of the parts 10 and 30 takes place via the first and second cylindrical parts 13 and 15 of the male end of part 10 and via the first and second cylindrical bores 33 and 35 of the female end of part 30, the external thread 14 and internal thread 34 being used solely as screw means.

FIG. 2 shows the assembling between the male and female ends of the two parts 10 and 30 of an assembly according to a second embodiment of the method of the invention, which differs from the embodiment illustrated in FIG. 1 in that the male end of the part 10 comprises a second conical part 18 instead of the second cylindrical part 15, whilst the female end of part 30 comprises a first conical bore 38 mating with the said second conical part, instead of the first cylindrical bore 33.

Therefore, for this assembling, the means which initiate the guiding of the parts 10 and 30 when being assembled are conical whilst the means which complete this guiding are cylindrical.

FIG. 3 shows the assembling between the male and female ends of the two parts 10 and 30 of an assembly according to a third embodiment of the method of the invention, which differs from the assembly operation illustrated in FIG. 1 in that the male end 11 of the part 10 comprises neither a cylindrical part 13 nor a cylindrical part 15 but only an external thread 14, whilst the female end 33 of the part 30 comprises neither bore 33 nor bore 35 but only an internal thread 34.

Therefore, for this assembling, the external thread 14 of the male end of part 10 and the internal thread 34 of the female end of part 30 act both as guide and as screw means.

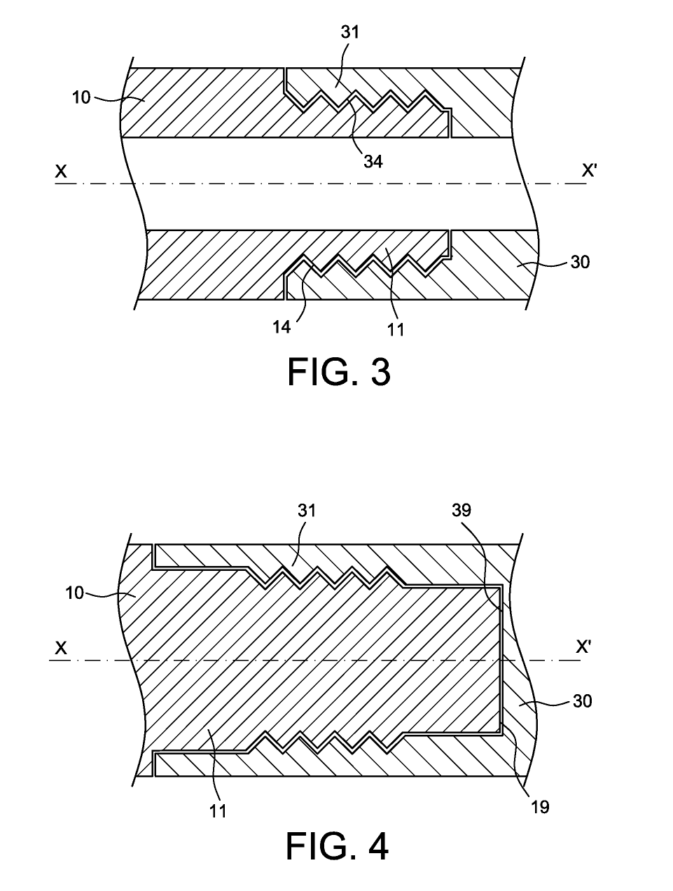

With reference now to FIG. 4 which shows the assembling between the male and female ends of the two parts 10 and 30 of an assembly according to a fourth embodiment of the method of the invention, which differs from the embodiment illustrated in FIG. 1 in that the parts 10 and 30 are not in the form of tubes but of rods neither comprising a conduit 12 for one thereof nor a conduit 32 for the other.

On this account, for this assembling, the free end 17 of the end 11 of part 10 and the shoulder 36 of part 30 are both replaced by solid walls respectively 19 and 39.

Aside from this difference, assembling is identical to that illustrated in FIG. 1.

Practical examples of implementation of the method of the invention will now be described.

### Example 1

Two tubular parts in Si₃N₄ are machined so that the first has a male end and the second has a female end such as illustrated in FIG. 1, and so that the clearances between these ends are 0.4 mm at the screw means and 0.05 mm at the guide means.

A first borosilicate glass paste is prepared, or paste A, by mixing a powder of particle size between 1 and 100 μm of a borosilicate glass which has a working temperature of 1070° C. and a coefficient of thermal expansion of 3.2×10⁻⁶/° C., with a serigraphy resin and isopropanol.

The mixing of these constituents and the homogenization of paste A are prepared by forming a paste in a three-cylinder mill.

A second paste of borosilicate glass is prepared, or paste B, of lower viscosity than paste A, also be pasting in a three-cylinder mill. The viscosity of paste B thus obtained is between 0.16 and 1 Pa.s under a shear gradient of 1 to 10 s⁻¹.

The qualitative and quantitative composition of the pastes A and B thus prepared is summarized in Table 1 below.

TABLE 1

| Constituents | Paste A | Paste B |
|---|---|---|
| Glass powder | 78% (w/w) | 51% (w/w) |
| Serigraphy resin | 12% (w/w) | 12% (w/w) |
| Isopropanol | 10% (w/w) | 35% (w/w) |
| Phosphoric ester | — | 1.1% (w/w) |

A layer of paste B is coated onto the entire outer surface of the male end of the first part using the dip-coating technique. The first part is drained in vertical position and oven-dried for 30 minutes.

The excess paste is then removed and the male end of the first part is immediately screwed onto the female end of the second part, but not fully so as to leave two longitudinal clearances of 3 mm each. The areas containing these clearances are filled with paste A using a spatula. This paste is left to dry naturally and the excess is removed by scraping.

The assembly thus obtained is placed in an oven and subjected to heat treatment comprising:

a first temperature rise, from ambient temperature up to 600° C., at a rate of 0.5° C./minute,

a second temperature rise from 600° C. to 940° C., at a rate of 5° C./minute,

a temperature hold at 940° C. for 15 minutes,

a first temperature drop, from 940° C. to 100° C., at a rate of 1° C./minute, and

a second temperature drop, from 100° C. to ambient temperature at a rate of 20° C./minute.

After cooling, the cavities existing in the glass joint formed between the parts (cavities resulting from shrinkage of the glass during the heat treatment) are filled with paste A using a spatula. This paste is left to dry naturally, the excess is removed by scraping and the assembly is again placed in the oven where it undergoes the same heat treatment as previously.

The seal of the borosilicate glass joint thus obtained is satisfactory for use as cathode compartment in an electrolyser dedicated to the electrochemical dissolution of actinide oxides. It is also satisfactory from the viewpoint of straightness and concentricity of the assembly thus formed.

### Example 2

Three tubular parts in Si₃N₄ are machined so that each thereof has a male end and a female end, such as illustrated in FIG. 3, and so that the clearance is 0.6 mm at the screw means and 0.2 mm at the guide means.

Three pastes in borosilicate glass are prepared, respectively A, B and C.

The composition of pastes A and B is identical to that of pastes A and B used above in Example 1.

Paste C is obtained by diluting a fraction of paste A in isopropanol so as to obtain the following composition:

| | |
|---|---|
| Glass powder | 72.2% (w/w) |
| Serigraphy resin | 11.1% (w/w) |
| Isopropanol | 16.7% (w/w) |

After impregnating the male end of the different parts with acetone, the entire outer surface of this end is coated with a layer of paste B using the dip-coating technique. The parts are drained in vertical position and oven-dried for 30 minutes.

The entire inner surface of the female end of the parts, that is previously impregnated with acetone, is coated with paste A using a spatula.

The parts are immediately assembled onto one another by screwing a male end with a female end, but this screwing is not fully carried out so as to leave between these ends two longitudinal clearances of 1 mm each, and the excess paste is cleaned. The portions containing these clearances are then filled with paste C using a syringe. This paste is left to dry naturally and the excess is removed by scraping. The assembly is again left to dry naturally. Under-fills are then filled with paste A and the excess removed by scraping.

The tube thus formed is placed on a specific refractory support which itself is placed in vertical position in an oven and heat treatment is applied thereto comprising:

a first temperature rise, from ambient temperature up to 50° C., at a rate of 0.5° C./minute,

a temperature hold at 50° C. for one hour,

a second temperature rise, from 50° C. to 600° C., at a rate of 0.5° C./minute,

a third temperature rise, from 600° C. to 940° C., at a rate of 5° C./minute,

a temperature hold at 940° C. for 15 minutes,

a first temperature drop from 940° C. to 100° C., at a rate of 1° C./minute, and

a second temperature drop, from 100° C. to ambient temperature at a rate of 20° C./minute.

After cooling, the cavities existing in the glass joints formed between the parts are filled with paste A using a spatula. This paste is left to dry naturally and the excess removed by scraping, and the tube is again placed in the oven where it undergoes the same heat treatment as previously.

Here also, the seal of the borosilicate glass joints thus obtained is satisfactory for use as cathode compartment in an electrolyser dedicated to the electrochemical dissolution of actinide oxides. The same applies concerning the straightness and concentricity of the assemblies thus formed.

### Example 3

Four tubular parts in Si₃N₄ are machined so that they each have a male end and a female end such as illustrated in FIG. 1 and so that the clearances are 0.4 mm at the screw means and 0.1 mm at the guide means.

Three pastes of borosilicate glass are prepared, respectively A, B and C, having strictly identical composition to that of pastes A, B and C used above in Example 2.

After impregnating the male end of the different parts with water and then acetone, the outer surface of this end is coated with a layer of paste B using the dip-coating technique, except at its first cylindrical part. The parts are drained in vertical position and oven-dried for 30 minutes.

The bottom of the internal thread of the female end of the parts, previously impregnated with water then acetone, is coated with paste C using a spatula.

The parts are immediately assembled with each other by screwing a male end onto a female end but this screw operation is not fully completed so as to leave between the parts two longitudinal clearances of 1 mm each and the excess paste is cleaned away. The portions containing these clearances are then filled with paste C using a syringe. This paste is left to dry naturally and the excess removed by scraping. The assembly is again left to dry naturally. The under-fills are filled with paste A and the excess paste removed by scraping.

The tube thus obtained is placed in a specific refractory support which itself is placed in vertical position in an oven where it undergoes identical heat treatment to the treatment applied in Example 2 above.

Here also, the seal of the borosilicate glass joints obtained is satisfactory for use as cathode compartment in an electrolyser dedicated to the electrochemical dissolution of actinide oxides. The same applies with respect to the straightness and concentricity of the assemblies thus formed.

### Example 4

Four tubular parts in Si₃N₄ are machined so that they each have a male end and a female end such as illustrated in FIG. 2, and so that the clearances are 0.4 mm at the screw means and 0.1 mm at the guide means.

Three pastes of borosilicate glass are prepared, respectively A, B and C, having strictly identical composition to that of pastes A, B and C used in Examples 2 and 3 above, aside from the fact that the borosilicate glass powder in these pastes has a particle size of between 1 and 25 μm.

After impregnating the male end of the different parts with acetone, the outer surface of this end is coated with a layer of paste B using the dip-coating technique, except at its first cylindrical part. The parts are drained in vertical position and oven-dried for 30 minutes.

The bottom of the thread of the female end of the parts, previously impregnated with acetone, is coated with paste C using a spatula.

The parts are immediately assembled together by screwing a male end onto a female end but not completely so as to leave between them two longitudinal clearances of 0.5 mm each, and the surplus paste is cleaned off. The portions containing these clearances are filled with paste C using a syringe. This paste is left to dry naturally, and the excess paste is removed by scraping. The assembly is again left to dry naturally. The under-fills are filled with paste A and the excess removed by scraping.

The tube thus obtained is placed in a specific refractory support itself placed in vertical position in an oven where it undergoes heat treatment identical to that applied in Example 2 above.

Here also, the seal of the borosilicate glass joints thus obtained is satisfactory for use as cathode compartment in an electrolyser dedicated to the electrochemical dissolution of actinide oxides. The same applied with respect to the straightness and concentricity of the assemblies thus formed.

### CITED REFERENCES

[1] FR-A-2 738 165

[2] FR-A-2 131 571

[3] JP-A-2004/224594

1. A method for the fluid-tight assembly of two parts in silicon nitride of which one comprises a male end and the other comprises a female end, each of these ends being provided with mechanical assembly means which are able to cooperate together and delimit a space between them under assembling conditions, said method comprises:
assembling said parts by cooperation between the mechanical assembly means of the male and female ends;
filling the space existing under assembling conditions between these assembly means with a glass joint;
and is characterized in that the filling comprises:
coating, before assembling the parts, the mechanical assembly means of one and/or the other of the male and female ends with a borosilicate glass paste;
applying heat treatment to the parts, after their assembly, to induce the formation in said space of a borosilicate glass joint by softening and flowing of the borosilicate glass present in said paste, then solidifying the joint thus formed,

2. The method according to claim 1, wherein the borosilicate glass contained in the paste is chosen from among the borosilicate glasses having:
(1) a coefficient of thermal expansion of 2.5×10⁻⁶/° C. to 5.0×10⁻⁶/° C. at between 20° C. and 800° C.; and/or
(2) a working temperature of 900° C. to 1300° C.

3. The method according to claim 1, wherein the borosilicate glass is present in the borosilicate glass paste in the form of a powder dispersed in a binder.

4. The method according to claim 3, wherein the borosilicate glass powder is formed of particles whose size, such as determined by laser particle measurement, is between 0.1 μm and 1 mm.

5. The method according to claim 3, wherein the borosilicate glass paste, in addition to the borosilicate glass powder and the binder, comprises a dispersing agent for mineral powders and/or a solvent.

6. The method according to claim 3, wherein the borosilicate glass paste in weight percentage comprises:
from 30 to 90% of the borosilicate glass powder;
up to 30% of the binder;
from 0 to 5% of a dispersant for mineral powders; and
from 0 to 50% of a solvent.

7. The method according to claim 1, wherein the borosilicate glass paste has a viscosity, such as determined at ambient temperature using a rotational viscometer with defined shear velocity gradient, of 0.01 Pa.s to 100 Pa.s under a shear gradient of 1 to 10 s⁻¹.

8. The method according to claim 1, wherein the coating of the mechanical assembly means of the male end with the borosilicate glass paste is performed by immersing.

9. The method according to claim 8, wherein the borosilicate glass paste, used to coat the mechanical assembly means of the male end, has a viscosity such as determined at ambient temperature using a rotational viscometer with defined shear velocity gradient, of between 0.01 Pa.s and 5 Pa.s under a shear gradient of 1 to 10 s⁻¹.

10. The method according to claim 1, wherein the parts are assembled by screwing.

11. The method according to claim 1, wherein the space existing between the mechanical assembly means measures 0.1 mm and 4 mm in width.

12. The method according to claim 10, wherein the male end having a free end which, under screw conditions, faces a shoulder carried by the female end, and the female end having a free end which, under screw conditions, faces a shoulder carried by the male end, screwing is conducted so as to maintain between each of said free ends and their opposite-facing shoulder a space which is filled with borosilicate glass paste.

13. The method according to claim 12, wherein the width of the space existing between each of the free ends of the male and female ends and their opposite-facing shoulder does not exceed 5 mm.

14. The method according to claim 12, wherein the paste used to fill the space existing between each of the free ends of the male and female ends and their opposite-facing shoulder has a viscosity, such as determined at ambient temperature using a rotational viscometer with defined shear velocity gradient, of 0.01 Pa.s to 5 Pa.s under a shear gradient of 1 to 10 s⁻¹.

15. The method according to claim 1, wherein the heat treatment comprises:
one or more temperature rises at a rate of 0.1° C./minute to 10° C./minute, optionally with one or more intermediate isothermal temperature holds, until a maximum temperature is reached, said maximum temperature being between 600° C. and 1200° C.;
a temperature hold at the maximum temperature, said temperature being held for between 1 minute and 120 minutes
one or more temperature drops, at a rate of 0.1° C./minute to 5° C./minute, optionally with one or more intermediate isothermal temperature holds, until a temperature is reached slightly lower than the glass transition temperature of the borosilicate glass so as to limit the stress level in this glass; and
one or more temperature drops, at a rate of 0.1° C./minute to 5° C./minute, until ambient temperature is reached.

16. The method according to claim 1, which further comprises filling of the cavities present in the glass joint obtained after heat treatment and which are accessible, with the borosilicate glass paste, and applying to the parts additional heat treatment identical to the preceding heat treatment.

17. The method according to claim 1, wherein each of the male and female ends comprises guide means different from the mechanical assembly means, which are capable of cooperating together and which delimit between them, under assembling conditions, a space whose width is narrower than the width of the space existing between the mechanical assembly means.

18. The method according to claim 17, wherein the space existing between the guiding means measures between 0.05 mm to 2 mm in width.

19. The method according to claim 17, which further comprises, before assembling of the parts, coating all or part of the guide means of one and/or the other of the male and female ends.

20. The method according to claim 1, wherein the parts to be assembled are parts through which a conduit passes.

21. A method for the manufacture of electrolytic membranes intended for electrolysers dedicated to the electrochemical dissolution of actinide oxides, which comprises implementing a method according to claim 1.
